(19) United States
(12) Patent Application Publication
(10) Pub. No.: US 2006/0112208 A1
(43) Pub. Date: May 25, 2006

(54) Interrupt thresholding for SMT and multi processor systems

(75) Inventors: Jos Manuel Accapadi, Austin, TX (US); Andrew Dunshea, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/996,307

(22) Filed: Nov. 22, 2004

(51) Int. Cl. G06F 13/24; G06F 13/26

(52) U.S. Cl. 710/265; 710/262; 710/264

(57) ABSTRACT

A method, system and computer program product for processing interrupts in a multi-processor system is provided. The method, system and computer program product process interrupts utilizing an unequal scheduling policy in order to achieve SLA target goals for interrupt processing. In a method of the present invention an interrupt is received. A determination is made as to whether the interrupt is assigned to a specific processor. If the interrupt is not assigned to a specific processor then a processor is selected from the group of processors based on their respective interrupt priority levels. Specifically, one processor is selected from all the processors that have the highest interrupt priority level. After the interrupt has been processed by the selected processor, a determination is made as to whether the selected processor has exceeded its threshold processing level. If threshold processing level has been exceeded, the selected processor's interrupt priority level is lowered.

### BACKGROUND OF THE INVENTION

1. Technical Field

The present invention relates in general to a system and method for processing interrupts on symmetric multi-thread (SMT) and symmetric multi-processor (SMP) architecture systems. Specifically, the present invention relates to a system and method for decreasing interrupt priorities for processors in SMT and SMP systems.

2. Description of Related Art

The fundamental structure of a modern computer includes peripheral devices to communicate information to and from the outside world; such peripheral devices may be, for example, keyboards, monitors, tape drives, and communication lines coupled to a network. Also included in the basic structure of the computer is the hardware necessary to receive process and deliver this information from and to the outside world, including components such as busses, memory units, input/output (I/O) controllers, storage devices, and at least one central processing unit (CPU). The CPU is the brain of the system. The CPU executes the instructions that comprise a computer program and directs the operation of other system components.

From the standpoint of the computer's hardware, most systems operate in fundamentally the same manner. Processors actually perform very simple operations quickly, such as arithmetic, logical comparisons and movement of data from one location to another. Programs that direct a computer to perform massive numbers of these simple operations give the illusion that the computer is doing something sophisticated. What is perceived by the user as a new or improved capability of a computer system, however, actually may be the machine performing the same simple operations, only much faster and/or much more efficiently.

A thread is a unit of software execution on a multi-processing computer. On such a computer, software programs are executed in units of execution called “processes” that include all the processor registers, code segment and offset registers, data segment and offset registers, stack segment and offset registers, flag registers, instruction pointer registers, program counters, and so on, needed for execution of software programs. For efficiency, processes are often further organized as threads, where each thread of a process individually possesses all the attributes needed for execution except that a thread shares memory among all the threads of a process, thereby reducing the overhead of operating system switches from thread to thread.

Each thread in a multi-processor computer typically is dispatched to run on a processor for a time slice, which is a predetermined maximum period of time for which the thread may retain possession of the processor. While a thread is running on a processor, the thread may be interrupted by interrupts. The interrupted thread never knows that it has been interrupted. However, if the thread is interrupted often enough, there is an effect on the thread's overall performance despite the fact that the thread itself is not aware of the interruptions.

An interrupt is a mechanism by which a computer sub-system or module external to a processor may interrupt the otherwise normal flow of operations to the processor. One type of interrupt may be referred to as a “program flow interrupt” where an interrupt interrupts the sequence of instructions being executed by the program. For example, a return from interrupt instruction may redirect the program flow to another address, e.g., an address of the instruction following the instruction that caused the interrupt. In another example, an instruction may be to divide by zero. Upon dividing by zero, a hardware fault may occur thereby generating an interrupt to be handled by an interrupt handling logic unit. The interrupt handling logic unit may handle the hardware fault by redirecting the program flow to an address indicated by the interrupt (a pointer). This address may be the start of an interrupt handling routine to handle the fault. Upon completion of the interrupt handling routine, the program flow may return to executing the instruction following the fault.

Another type of interrupt may be referred to as an “asynchronous interrupt” which is generated independent of the program flow. For example, an interrupt may be generated by an internal timer that may continually interrupt the processor several times per second to keep the time of day current or for timesharing purposes. AS with program flow interrupts, upon the issuance of an asynchronous interrupt, an interrupt handling logic unit may handle the interrupt.

Modern interrupt handling logic units are typically split into two parts, a first level interrupt handler and a second level interrupt handler. The first level interrupt handler discovers the cause of the interrupt. The first level interrupt handler typically does not however process the interrupt. The first level interrupt handler instead typically calls a second level interrupt handler to process the interrupt. After being called by the first level interrupt handler, the second level interrupt handler sits in the ready queue until processor time becomes available to process the interrupt.

However, simply waiting for the next available processor time in order to process the interrupt is not an efficient method of maximizing the resources of an SMP system. Typically, in SMP systems processor time is sold to clients in service level agreements (SLAs). These SLAs often establish performance standards based on the percentage of time actually spent processing threads. For example an SLA may establish that no more than 5% per unit of time can be spent processing interrupts. In another example the SLA might state that at least 90% per unit of time must be spent processing threads. Therefore, if a thread is interrupted often enough, SLA performance standards will not be met.

Consider the example of a processor with a time slice of 10 milliseconds that is interrupted 5 times during a single time slice of operation. Assume that each interrupt requires 1 millisecond to process. The processor has now spent 50% of its time processing interrupts instead of processing threads. For a processor that is trying to meet the performance standards set forth in an SLA, this fact pattern is very inefficient. Current solutions include binding interrupt processing exclusively to a single processor or to a subset of processors on a system and refraining from assigning threads to processors reserved for interrupt processing. Such an approach is very static and has several drawbacks, including the inability to sell processing time on the processors reserved for interrupt processing and not being able to spread out the processing of interrupts when other processors would be otherwise available to do so. Other available methods include assigning interrupts in a random fashion or using a round robin type of assignment process. However, both the processes are inherently equal, as the processes both share out equally the burden of processing the interrupts among all the processors, and therefore do not allow for available processing time to reach various performance standards on different processors within a single SMP system.

Therefore, it would be advantageous to have an improved method, apparatus and computer instruction for scheduling interrupt processing through use of unequal scheduling policy, which is a scheduling policy that does not evenly distribute the burden of processing the interrupts among all the processors, instead choosing to proportion the interrupt processing load based on the service level commitments, in a multi-processor computer system.

### SUMMARY OF THE INVENTION

The present invention provides a method, apparatus and computer instruction for processing interrupts in a multi-processor system. The method, system and computer program product process interrupts utilizing an unequal scheduling policy in order to achieve SLA target goals for interrupt processing. An interrupt is received and a determination is made as to whether the interrupt is assigned to a specific processor. If the interrupt is not assigned to a specific processor then a processor is selected from the group of processors based on their respective interrupt priority levels. Specifically, one processor is selected from among all the processors that have the highest interrupt priority level. The interrupt is then sent to the selected processor. After the interrupt has been processed by the selected processor, the selected processor is then checked to see if the selected processor has exceeded its interrupt processing threshold level. If the selected processor has exceeded its interrupt processing threshold level, the selected processor's interrupt priority level is lowered. In this manner multi-processor CPU resources are more effectively utilized so that SLA performance standards can be more easily met.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented according to a preferred embodiment of the present invention;

FIG. 3 is a block diagram of an interrupt handler multiple processors in accordance with a preferred embodiment of the present invention; and

FIG. 4 is a flowchart that illustrates a method for checking for interrupt thresholds in accordance with a preferred embodiment of the present invention.

FIG. 5 is a flowchart that illustrates a method for checking for interrupt thresholds on a sliding scale in accordance with a preferred embodiment of the present invention.

FIG. 6 is a flowchart that illustrates a method for resetting processor mask settings in accordance with a preferred embodiment of the present invention.

### DETAILED DESCRIPTION OF THE PREFERRED EMBODIMENT

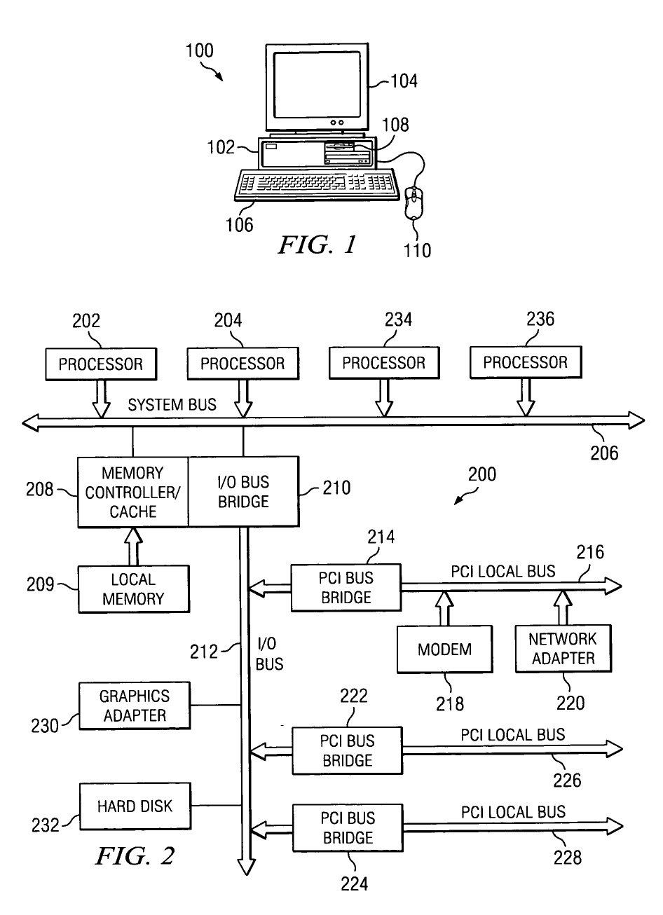

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202, 204, 234 and 236 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The present invention provides a method, apparatus and computer instruction for processing interrupts in a multi-processor system. An interrupt is received and a determination is made as to whether the interrupt is assigned to a specific processor. If the interrupt is not assigned to a specific processor then a processor is selected from the group of processors based on their respective interrupt priority levels. The interrupt priority level for each processor is stored as a mask setting. Specifically, one processor is arbitrarily selected from among all the processors that have the highest interrupt priority level. However, there are many ways by which the interrupt handler can select a processor out of the group of processors with the highest interrupt priority level including, but not limited to, randomly or by a round-robin type of system. The interrupt is then sent to the selected processor. After the interrupt has been processed by the selected processor, the selected processor is then checked to see if the selected processor has exceeded its threshold processing level. If the selected processor has exceeded its threshold processing level, the selected processor's interrupt priority level is lowered and the processor's mask setting is adjusted accordingly. In some chip sets a higher interrupt priority number may indicate a higher interrupt priority level, whereas in other chip sets a higher interrupt priority number indicates a lower interrupt priority level. Therefore, adjusting the interrupt priority level to indicate a lower interrupt priority level may involve increasing the mask setting in some instances and decreasing the mask setting in other instances.

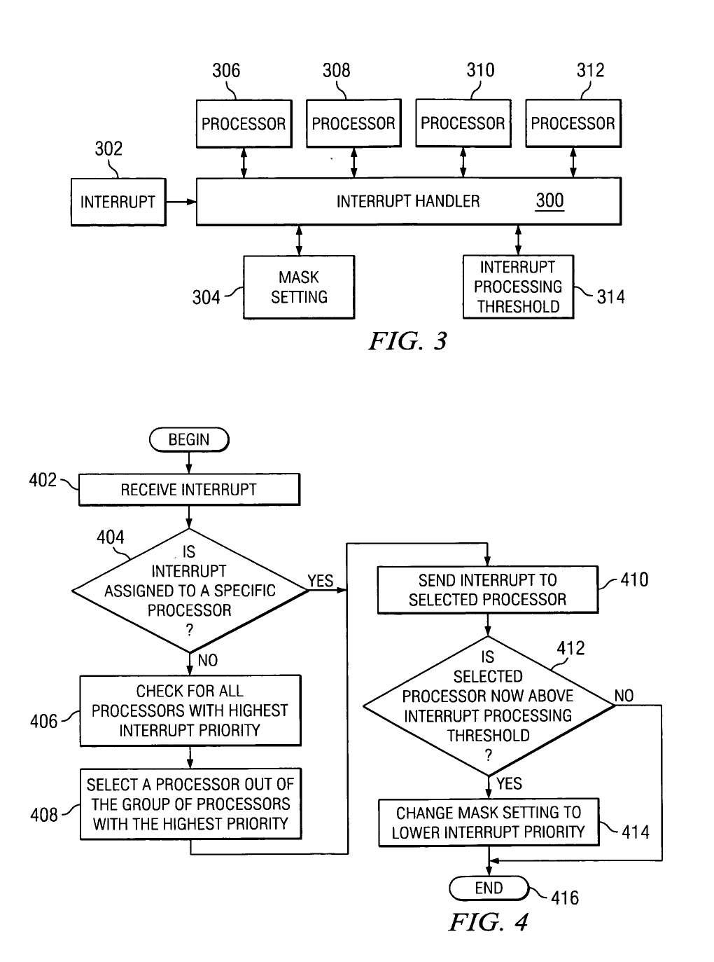

With reference now to FIG. 3, a block diagram of an interrupt handler with multiple processors is shown in accordance with a preferred embodiment of the present invention. Interrupt handler 300 receives interrupt 302. Interrupt handler 300 checks processor 306, 308, 310 and 312 mask setting 304. Mask setting 304 contains interrupt priority levels for each processor 306, 308, 310 and 312. Based on mask setting 304, interrupt handler 300 determines which processor 306, 308, 310 and 312 have the highest priority for interrupt processing. Interrupt handler 300 then sends interrupt 302 to be processed by one of processor 306, 308, 310 and 312. After processor 306, 308, 310 or 312 has processed interrupt 302, interrupt handler 300 checks to see if processor 306, 308, 310 and 312 has exceeded its interrupt processing threshold 314. Interrupt processing threshold 314 contains performance standards for each processor 306, 308, 310 and 312.

Performance standards can consist of many different standards, including, but not limited to, a percentage of time spent processing interrupts over a given time period, a percentage of interrupts processed over a given time period, a total number of interrupts processed, a total time spent processing interrupts, and a total number of interrupts processed over a given time period. If interrupt processing threshold 314 has been exceeded then interrupt handler 300 changes mask setting 304, for the appropriate processor 306, 308, 310 and 312, to a lower interrupt priority.

While FIG. 3 has been discussed in terms of physical processors, those of ordinary skill in the art will appreciate that FIG. 3 applies to logical processors as well. For example, in a SMP system each physical processor might have two logical processors such that:

physical proc 1: logical proc 1/logical proc 2.

physical proc 2: logical proc 3/logical proc 4.

physical proc 3: logical proc 5/logical proc 6.

physical proc 4: logical proc 7/logical proc 8.

Logical proc 1 might have an interrupt processing threshold of 10% of the time per 10 milliseconds spent processing interrupts. Logical proc 2 might have an interrupt processing threshold of 20% of the time per 10 milliseconds spent processing interrupts. Logical proc 3 might have an interrupt processing threshold of 1 minute spent processing interrupts. Physical proc 4 might have an interrupt processing threshold of 1000 interrupts handled. Initially the mask setting for each processor, physical and logical, would be at the highest priority level, which in this example would be 0 (zero). Assuming that logical proc 1 exceeds its interrupt processing threshold before logical proc 2, logical proc 1's interrupt priority is lowered by changing its mask setting to 1. From that point on, whenever physical proc 1 receives an interrupt, the interrupt will be processed by logical proc 2 until such time as logical proc 2 also exceeds its interrupt processing threshold. At this time, once both logical processors, in this case logical proc 1 and logical proc 2, have exceeded their respective interrupt processing thresholds, the interrupt priority of the physical processor, in this case physical proc 1,is lowered. In this example this is done by changing physical proc 1's mask setting to 1. Once logical proc 3 exceeds its interrupt processing threshold then logical proc 3's interrupt priority will be lowered by changing its mask setting to 1. After physical proc 4 has processed 1000 interrupts its interrupt priority will be lowered by changing its mask setting to 1. Of course those of ordinary skill in the art will appreciate that other mask settings besides 1 can be used to lower the interrupt priority as these settings are only limited by the chip set being used.

Once all the interrupt processing thresholds have been exceeded in the example setup above, interrupt processing would be handled as described hereafter. Physical proc 1 and physical proc 4 have a mask setting of 1 whereas physical proc 2 and physical proc 3 have a mask setting of 0. Therefore, when an interrupt is received, the interrupt will be sent to either physical proc 2 or physical proc 3. In the case of physical proc 2, when the interrupt is received, logical proc 3 has a mask setting of 1 whereas logical proc 4 has a mask setting of 0, so the interrupt will be sent to logical proc 4.

It should be understood that the process illustrated in FIG. 3 is exemplary only and may be modified in various ways depending on particular implementations. For example, there are many ways by which the interrupt handler can select a processor out of the group of processors with the highest interrupt priority level including, but not limited to, randomly or by a round-robin type of system.

Those of ordinary skill in the art will appreciate that the hardware depicted in FIG. 3 may vary. For example, although the system shown in FIG. 3 contains 4 processors, more or fewer processors may be used depending on the implementation. The depicted example is not meant to imply architectural limitations with respect to the present invention.

FIG. 4 is a flowchart that illustrates a method for checking for interrupt thresholds in accordance with a preferred embodiment of the present invention. The method in FIG. 4 may be implemented in an interrupt handler, such as interrupt handler 300 in FIG. 3.

The method begins when an interrupt is received by the interrupt handler (step 402). A determination is made as to whether the interrupt is assigned to a specific processor (step 404). If the interrupt is assigned to a specific processor (yes output of step 404) then the interrupt is sent to the appropriate processor (step 410). If the interrupt is not assigned to a specific processor, (no output of step 404) then a check of the mask settings is made to determine which processors have the highest interrupt priority (step 406). These mask settings are ones like those in mask setting 304 of FIG. 3. After a determination is made as to which processors have the highest interrupt priority, a processor out of the group of processors with the highest interrupt priority is selected to send the interrupt to (step 408). The interrupt is sent to the selected processor (step 410). After the interrupt has been processed by the selected processor, the interrupt handler then checks to see if the selected processor has exceeded its interrupt processing threshold (step 412). This interrupt processing threshold is like those in interrupt processing threshold 314 of FIG. 3. If the interrupt handler determines that the interrupt processing threshold has been exceeded, (yes output of step 412) then the interrupt handler changes the mask setting to a lower interrupt priority (step 414) and the method ends (step 416). If the interrupt handler determines that interrupt processing threshold has not been exceeded, (no output of step 412) the method ends (step 416).

It should be understood that the process illustrated in FIG. 4 is exemplary only and may be modified in various ways depending on particular implementations. For example, there are many ways by which the interrupt handler can select a processor out of the group of processors with the highest interrupt priority level including, but not limited to, randomly or by a round-robin type of system.

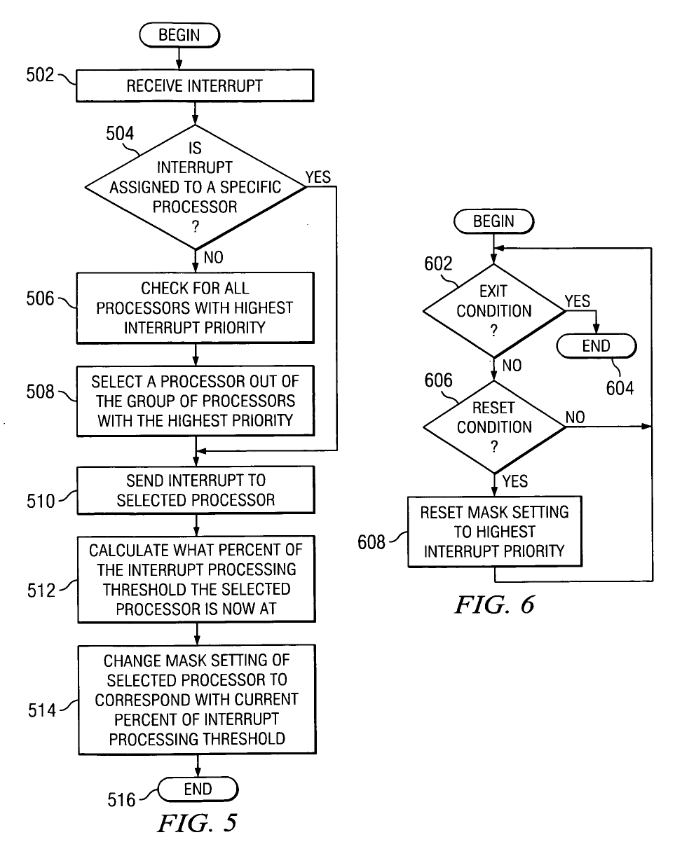

FIG. 5 is a flowchart that illustrates a method for checking for interrupt thresholds on a sliding scale in accordance with a preferred embodiment of the present invention. The method in FIG. 5 may be implemented in an interrupt handler, such as interrupt handler 300 in FIG. 3.

The method begins when an interrupt is received by the interrupt handler (step 502). A determination is made as to whether the interrupt is assigned to a specific processor (step 504). If the interrupt is assigned to a specific processor (yes output of step 504) then the interrupt is sent to the appropriate processor (step 510). If the interrupt is not assigned to a specific processor, (no output of step 504) then a check of the mask settings is made to determine which processors have the highest interrupt priority (step 506). These mask settings are ones like those in mask setting 304 of FIG. 3. After a determination is made as to which processors have the highest interrupt priority, a processor out of the group of processors with the highest interrupt priority is selected to send the interrupt to (step 508). The interrupt is sent to the selected processor (step 510). After the interrupt has been processed by the selected processor, the interrupt handler determines what percent of the interrupt processing threshold the selected processor is at (step 512). This interrupt processing threshold is like those in interrupt processing threshold 314 of FIG. 3. The interrupt handler changes the mask setting of the selected processor to correspond with the current percent of threshold (step 514) and the method ends (step 516).

It should be understood that the process illustrated in FIG. 5 is exemplary only and may be modified in various ways depending on particular implementations. For example, there are many ways by which the interrupt handler can select a processor out of the group of processors with the highest interrupt priority level including, but not limited to, randomly or by a round-robin type of system.

Additionally, determining what mask setting corresponds to the current percent of interrupt processing threshold exceeded will vary depending on the chip set used and what limitations the user may want to put on the number of mask settings. In some chip sets, a higher number indicates a higher interrupt priority, while in other chip sets a high number indicates a lower interrupt priority. Therefore in some instances the mask setting will need to be increased while in other instances the mask setting will need to be decreased in order to lower the interrupt priority of the processor.

Furthermore, the number of priority levels available will vary depending on the particular chip set or the user may wish to use only a limited number of priority levels. For example, if only 10 priority levels are used, then the mask settings which correspond to the current percentage of threshold level would be based on increments of every 10 percent, or part thereof, of the threshold level. In contrast, if 100 priority levels were used, then the mask settings which correspond to the current percentage of threshold level would be based on increments of every 1 percent, or part thereof, of the threshold level.

FIG. 6 is a flowchart that illustrates a method for resetting processor mask settings in accordance with a preferred embodiment of the present invention. The method in FIG. 6 may be implemented in an interrupt handler, such as interrupt handler 300 in FIG. 3.

The method begins by determining if an exit condition exists (step 602). Many different conditions can be exit conditions. Some example conditions which may be used as exit conditions include, but are not limited to, the data processing system being shut down, or after passage of a specific amount of time, or at particular times of day. If an exit condition does exist (yes response to step 602) then the method ends (step 604). If an exit condition does not exist (no response to step 602) then a determination is made as to whether a reset condition exists (step 606).

Many different conditions can be reset conditions. Some example conditions which may be used as reset conditions include, but are not limited to, passage of a specific amount of time, or after a certain number of interrupts have been processed, or when interrupt priority reaches a certain level, or if a processor has completed a time consuming task. If a reset condition does exist (yes response to step 606) then the mask setting is reset to the highest interrupt priority (step 608). This mask setting is like those in mask setting 304 of FIG. 3. The method then returns to step 602. If an exit condition does not exist (no response to step 606) then the method returns to step 602.

It should be understood that the process illustrated in FIG. 6 is exemplary only and may be modified in various ways depending on particular implementations. For example, the method itself could be applied to each processor in a multi-processor individually, with separate exit and reset conditions existing for each processor or the method might be applied uniformly to all the processors in the system or the method could be applied to sub-sets of processors in a multi-processor individually, with separate exit and reset conditions existing for each sub-set of processors.

Thus, the present invention solves the disadvantages of the prior art by providing an unequal scheduling policy for processing interrupts on SMT and SMP systems. The present invention provides a method, apparatus and computer instruction for processing interrupts in a multi-processor system. An interrupt is received and a determination is made as to whether the interrupt is assigned to a specific processor. If the interrupt is not assigned to a specific processor then a processor is selected from the group of processors based on their respective interrupt priority levels. Specifically, one processor is selected from among all the processors that have the highest interrupt priority level. The interrupt is then sent to the selected processor. After the interrupt has been processed by to the selected processor, the selected processor is then checked to see if the selected has exceeded its threshold processing level. Threshold levels can measured against many different standards, including, but not limited to, a percentage of time spent processing interrupts over a given time period, a percentage of interrupts processed over a given time period, a total number of interrupts processed, a total time spent processing interrupts, and a total number of interrupts processed over a given time period. If the selected processor has exceeded its threshold processing level, the selected processor's interrupt priority level is lowered. In this manner multi-processor CPU resources are maximized so that SLA performance standards can be more easily met.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing interrupts, the method comprising:
associating a separate interrupt processing threshold for each processor;
responsive to receiving an interrupt, selecting a processor from a set of processors based on a priority scheme associated with the set of processors to form a selected processor, wherein the priority scheme is based upon the interrupt processing thresholds that have been set;
sending the interrupt to the selected processor; and
adjusting the priority scheme if the interrupt processing threshold for the selected processor is exceeded by processing the interrupt.

2. The method of claim 1, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

3. The method of claim 1 further comprising:
responsive to a determination that a reset condition exists, resetting a priority to the highest level.

4. The method of claim 1 further comprising:
monitoring a time the selected processor is in interrupt mode;
updating a target interrupt goal for the selected processor each time it is in interrupt mode; and
determining, based on the interrupt processing threshold, whether the selected processor should be less favored to process subsequent interrupts.

5. A method in a data processing system for processing interrupts, the method comprising:
associating a separate interrupt processing threshold for each processor;
responsive to receiving an interrupt, selecting a processor from a set of processors based on a priority scheme associated with the set of processors to form a selected processor, wherein the priority scheme is based upon the interrupt processing thresholds that have been set;
sending the interrupt to the selected processor; and
adjusting the priority scheme based on the percentage of the interrupt processing threshold that the selected processor has currently met by processing the interrupt.

6. The method of claim 5, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

7. The method of claim 5 further comprising:
responsive to a determination that a reset condition exists, resetting a priority to the highest level.

8. A computer program product in a computer readable medium for processing interrupts, comprising:
first instructions for associating a separate interrupt processing threshold for each processor;
second instructions, responsive to receiving an interrupt, for selecting a processor from a set of processors based on a priority scheme associated with the set of processors to form a selected processor, wherein the priority scheme is based upon the interrupt processing thresholds that have been set;
third instructions for sending the interrupt to the selected processor; and
fourth instructions for adjusting the priority scheme if the interrupt processing threshold for the selected processor is exceeded by processing the interrupt.

9. The computer program product of claim 8, wherein the processor is selected from one of a logical processor or a physical processor.

10. The computer program product of claim 8, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

11. The computer program product of claim 8 further comprising:
fifth instructions, responsive to a determination that a reset condition exists, for resetting a priority to the highest level.

12. A computer program product in a computer readable medium for processing interrupts, comprising:
first instructions for associating a separate interrupt processing threshold for each processor;
second instructions, responsive to receiving an interrupt, for selecting a processor from a set of processors based on a priority scheme associated with the set of processors to form a selected processor, wherein the priority scheme is based upon the interrupt processing thresholds that have been set;
third instructions for sending the interrupt to the selected processor; and
fourth instructions for adjusting the priority scheme based on the percentage of the interrupt processing threshold that the selected processor has currently met by processing the interrupt.

13. The computer program product of claim 12, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

14. A data processing system for processing interrupts, comprising:
an associating mechanism for associating a separate interrupt processing threshold for each processor;
a selecting mechanism, responsive to receiving an interrupt, for selecting a processor from a set of processors based on a priority scheme associated with the set of processors to form a selected processor, wherein the priority scheme is based upon the interrupt processing thresholds that have been set.;
a sending mechanism for sending the interrupt to the selected processor; and
an adjusting mechanism for adjusting a priority scheme if the interrupt processing threshold for the selected processor is exceeded by processing the interrupt.

15. The data processing system of claim 14, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

16. The data processing system of claim 14 further comprising:
a resetting mechanism, responsive to a determination that a reset condition exists, for resetting a priority to the highest level.

17. A data processing system for processing interrupts, comprising:
an associating mechanism for associating a separate interrupt processing threshold for each processor;
a selecting mechanism, responsive to receiving an interrupt, for selecting a processor from a set of processors based on a priority scheme associated with the set of processors to form a selected processor, wherein the priority scheme is based upon the interrupt processing thresholds that have been set;
a sending mechanism for sending the interrupt to the selected processor; and
an adjusting mechanism for adjusting the priority scheme based on the percentage of the interrupt processing threshold that the selected processor has currently met by processing the interrupt.

18. The data processing system of claim 17, wherein the processor is selected from one of a logical processor or a physical processor.

19. The computer program product of claim 17, wherein the interrupt processing threshold is selected from at least one of a percentage of time spent processing interrupts over a given time period, a percentage of interrupts processed over a given time period, a total number of interrupts processed, a total time spent processing interrupts, and a total number of interrupts processed over a given time period.

20. The data processing system of claim 17 further comprising:
a resetting mechanism, responsive to a determination that a reset condition exists, for resetting a priority to the highest level.
